(19) United States
(12) Patent Application Publication
(10) Pub. No.: US 2005/0042059 A1
(43) Pub. Date: Feb. 24, 2005

(54) Slide nut

(76) Inventor: Mark C. Bremer, Higganum, CT (US)

Correspondence Address: ALIX YALE & RISTAS LLP, 750 MAIN STREET, SUITE 1400, HARTFORD, CT, 06103, US

(21) Appl. No.: 10/644,234

(22) Filed: Aug. 20, 2003

(51) Int. Cl. F16B 37/08

(52) U.S. Cl. 411/433

(57) ABSTRACT

A slide nut includes a nut body defining a first bore extending axially therethrough for receiving the threaded shaft or rod and a second bore extending radially inward from the outer surface, through the first bore, and terminating at an end surface disposed intermediate the first bore and the outer surface. The second bore has first and second end segments and an intermediate segment disposed therebetween, the intermediate and first end segments forming a stop. A thumb piece disposed in the second bore has actuator and operator segments defining a stop. The operator segment is disposed in the intermediate segment and the operator segment extends from the operator segment through the first end segment to an outer end. An aperture in the actuator segment is in general registry with the first bore of the nut body. The aperture extends from a first end proximate to the operator segment to a threaded second end longitudinally spaced from the first end. A spring disposed within the intermediate segment of the nut body second bore biases the thumb piece away from the end of the second bore.

### BACKGROUND OF THE INVENTION

This invention relates generally to sliding, quick release nuts. More particularly, the present invention relates to sliding, quick release nuts which are removable from the threaded shaft to which they are coupled.

Sliding, quick release nuts which provide for selective sliding or threading motion with respect to a threaded shaft are known having been used as stops on drilling, depth milling and other similar machinery. Such sliding nuts typically are formed of a body including an axial bore and a transverse blind bore communicating with the axial bore. A thumb piece, having a transverse bore, is received in the body transverse bore such that the thumb piece transverse bore generally aligns with the body axial bore. The thumb piece bore (and body axial bore) are of a diameter sufficiently larger than the diameter of the threaded shaft with which the nut is to cooperate, to permit reception of the threaded shaft with a considerable clearance allowed for play. A portion of the interior of the thumb piece bore is threaded in a manner suitable for engagement with the threads of the shaft and the thumb piece is spring biased to bring the threaded portion into engagement with the shaft threads. Depressing the thumb piece against the spring bias, disengages the threaded portion of the thumb piece bore from the threaded shaft, and the play in the bore diameter permits sliding of the nut with respect to the shaft.

The conventional sliding nuts and the threaded shaft form an integral system which requires the presence of the threaded shaft within the thumb piece bore and the body axial bore to lock the thumb piece within the body axial bore. If the sliding nut is removed from the threaded shaft, the thumb piece and spring are free to fall out of the body axial bore. If the spring has a sufficiently strong spring force, it may eject the thumb piece from the body axial bore. Accordingly, conventional sliding nuts are not suitable for uses which require the sliding nut to be removed from the threaded shaft during any phase of such use.

SUMMARY OF THE INVENTION

Briefly stated, the invention in a preferred form is a slide nut which is mountable on a threaded shaft or rod. The slide nut comprises a nut body having an axis and an outer surface. The nut body has an axial bore for receiving the threaded shaft or rod and a stepped transverse bore extending radially inward from a first point on the outer surface, through the axial bore, and terminating at a second point on the outer surface. The transverse bore includes first and second end segments and an intermediate segment disposed therebetween. A stop is disposed intermediate the first end segment and the intermediate segment. A plug is mounted in the second end segment of the nut body transverse bore. A thumb piece includes an actuator segment disposed in the intermediate segment of the transverse bore and an operator segment extending from the actuator segment, through the first end segment of the transverse bore, to an outer end. A stop is disposed intermediate the actuator segment and the operator segment. The actuator segment has a transverse aperture extending from a first end proximate to the operator segment to a threaded second end longitudinally spaced from the first end. A biasing mechanism is disposed within the intermediate segment of the transverse bore between the plug and the actuator segment of the thumb piece. The biasing mechanism biases the thumb piece away from the plug. When a threaded shaft or rod is disposed in the axial bore of the nut body, the biasing mechanism urges the threaded second end of the transverse aperture into threaded engagement with the threaded shaft or rod, and when a threaded shaft or rod is not disposed in the axial bore of the nut body, the stop of the thumb piece engages the stop of the nut body transverse bore to limit radial movement of the thumb piece.

The intermediate segment has an inside diameter which is greater than the inside diameter of the first end segment, forming an inner shoulder within the transverse bore which defines the stop of the nut body transverse bore. The actuator segment of the thumb piece has an outside diameter which is greater than the outside diameter of the operator segment of the thumb piece, forming a circumferential outer shoulder which defines the stop of the thumb piece.

The first end segment of the transverse bore has an inner surface having a flattened section extending transversely to the axial bore and the operator segment of the thumb piece has a flattened portion extending transversely to the transverse aperture. The operator segment of the thumb piece has an overall outer diameter D₅ and an outer diameter D₇ at the flattened portion and the first end segment of the transverse bore has an overall inside diameter D₂ and an inside diameter D₈ at the flattened section, where D₂>D₅>D₈>D₇. Accordingly, the flattened section of the first end segment and the flattened portion of the operator segment index the thumb piece to the nut body whereby the transverse aperture is disposed in general registry with the nut body axial bore.

The outer surface of the plug and the outer surface of the nut body each having alternating, axially extending ridges and grooves forming a knurled outer surface. The plug includes at least one protrusion and the outer surface of the nut body also has at least one notch for receiving the protrusion, the notch and protrusion indexing the ridges and grooves of the plug to the ridges and grooves of the nut body.

It is an object of the invention to provide a new and improved quick release slide nut.

It is also an object of the invention to provide a quick release slide nut which retains all of the component structures of the nut when the slide nut is removed from a threaded shaft or rod.

Other objects and advantages of the invention will become apparent from the drawings and specification.

### BRIEF DESCRIPTION OF THE DRAWINGS

The present invention may be better understood and its numerous objects and advantages will become apparent to those skilled in the art by reference to the accompanying drawings in which:

FIG. 1 is a perspective view of a sliding nut in accordance with the invention;

FIG. 2 is a side view, partly in phantom, of the nut body of FIG. 1;

FIG. 3 is a front view, partly in phantom, of the nut body of FIG. 1;

FIG. 4 is an enlarged perspective view of the thumb piece of FIG. 1;

FIG. 5 is a side view of the thumb piece of FIG. 4;

FIG. 6 is a bottom view of the nut body of FIG. 1; and

FIGS. 7a and 7b are cross-sectional view of a sliding nut in accordance with the invention in the disengaged and engaged positions, respectively, on a threaded shaft.

### DETAILED DESCRIPTION OF THE PREFERRED EMBODIMENT

With reference to the drawings wherein like numerals represent like parts throughout the several figures, a slide nut 10 in accordance with the present invention includes a nut body 12, a plug 14, a thumb piece 16, and a biasing mechanism 18, such as a compression spring. Slide nut 10 may be used in place of a conventional quick release nut but is particulary adapted for use where the slide nut 10 must be or is customarily removed from the threaded shaft or rod 20. For example, U.S. Pat. No. 6,438,855 (Bremer) discloses a portable wheel alignment system for motorcycles which includes threaded rods and nuts which must be connected during installation of the system. After completion of the alignment procedure, the nuts must be disconnected from the threaded rod to remove the alignment system from the motorcycle wheel. To maintain full portability of the system, it is preferable that all of the nuts be removed from the threaded rods when the system is not in use.

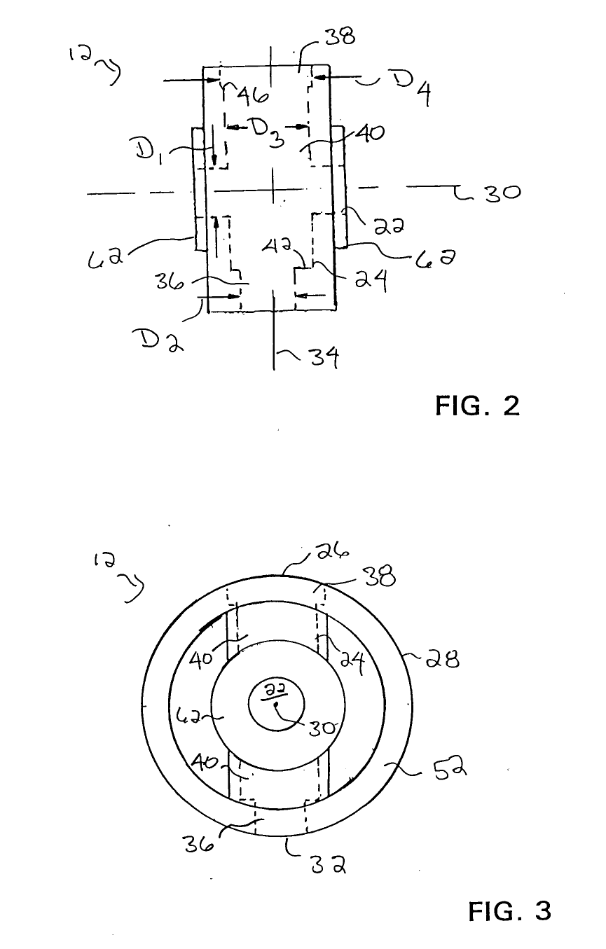

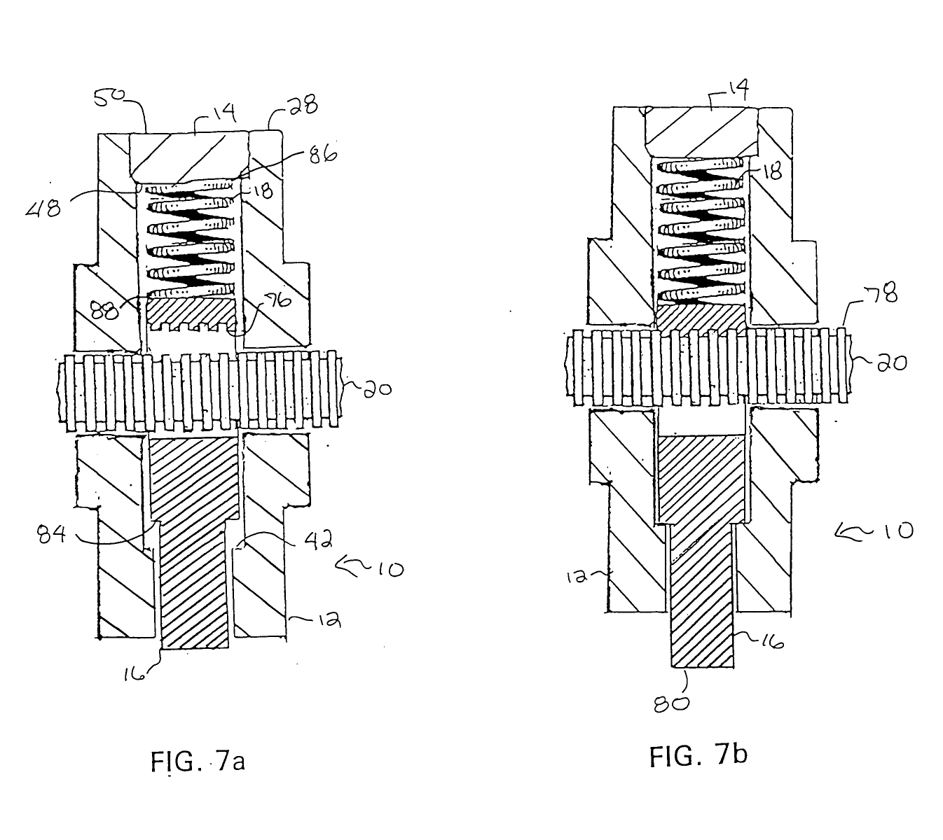

With reference to FIGS. 2, 3 and 6, the nut body 12 includes a bore 22, extending coaxially therethrough, which is adapted for receiving a threaded shaft 20 or rod (FIGS. 7a and 7b). The diameter D₁ of the axial bore 22 is chosen to closely receive the threaded shaft 20, permitting sliding in an axial direction, but relatively little lateral motion. In addition, a stepped transverse bore 24 extends radially inward from a first point 26 on the outer surface 28, through the axis 30 of the nut body 12, and terminates at a second point 32 on the outer surface 28, the first and second points 26, 32 being oppositely disposed on the outer surface 28. Transverse bore 24 has a substantially circular cross-section and an axis 34 which preferably intersects the axis 30 of axial bore 22.

The transverse bore 24 includes first and second end segments 36, 38 and an intermediate segment 40 disposed therebetween. The first end segment 36 has an inside diameter D₂ which is smaller than the inside diameter D₃ of the intermediate segment 40, forming an inner shoulder 42 within the transverse bore 24. The inner surface of the first end segment 36 includes a flattened section 44 which extends transversely to the axial bore 22. Flattened section 44 acts as a key for indexing the thumb piece 16, as explained further below. The second end segment 38 has an inside diameter D₄ which is greater than the inside diameter D₃ of the intermediate segment 40, forming an inner shelf 46 within the transverse bore 24. The plug 14 is inserted into the second end segment 38 of the transverse bore 24 until the inner surface 48 of plug 14 contacts inner shelf 46, aligning the outer surface 50 of plug 14 with the outer surface 28 of the nut body 12, and is fixedly mounted therein. The values of D₂, D₃ and D₄ are substantially constant for the length of the first end segment, intermediate segment and second end segment, respectively.

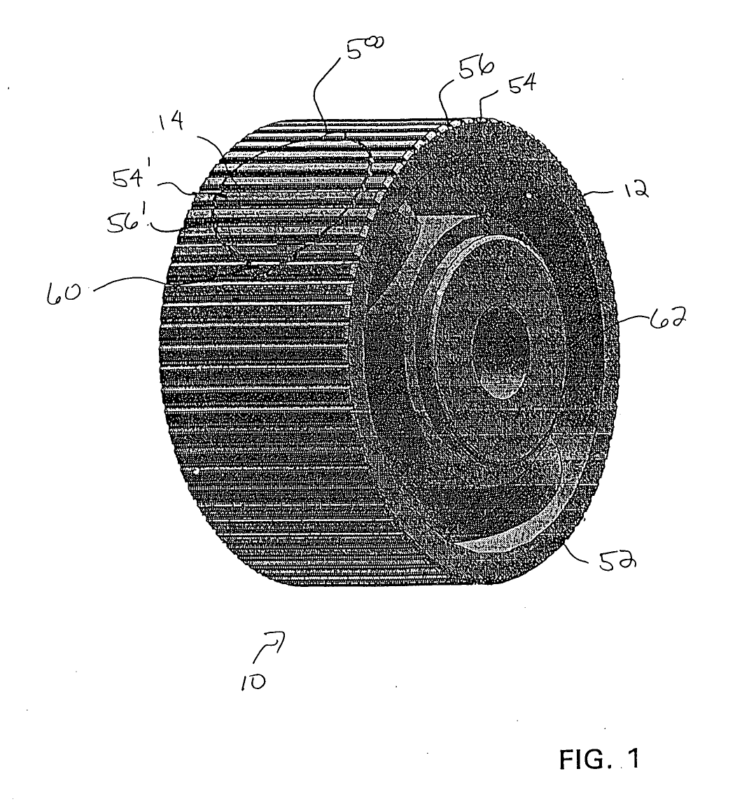

The outer portion 52 of the nut body 12 and the outer surface 50 of plug 14 have alternating, axially extending ridges 54, 54′ and grooves 56, 56′ forming a knurled outer surface (FIG. 1) to facilitate grasping the slide nut 10. Notches 58 in outer portion 52 and protrusions 60 on plug 14 index the plug 14 to the nut body 12 such that the ridges 54′ and grooves 56′ of plug 14 are disposed in general registry with the ridges 54 and grooves 56 of nut body 12. In an embodiment for light-duty use, the nut body 12 is composed of injection molded polymeric material. In this embodiment, a coaxial sleeve 62 extends axially beyond each side of the outer portion 52 to provide greater mechanical strength to the interface with the metallic threaded shaft 20. In an embodiment for medium to heavy-duty use, the nut body 12 is composed of machined metal. Preferably, the outside diameter of the nut body 12 is 1.5 inches, allowing the slide nut 10 to easily grasped. However, it should be appreciated that the specific dimensions of the nut body 12 and the plug 14 may be adjusted to any specific use of the slide nut 10.

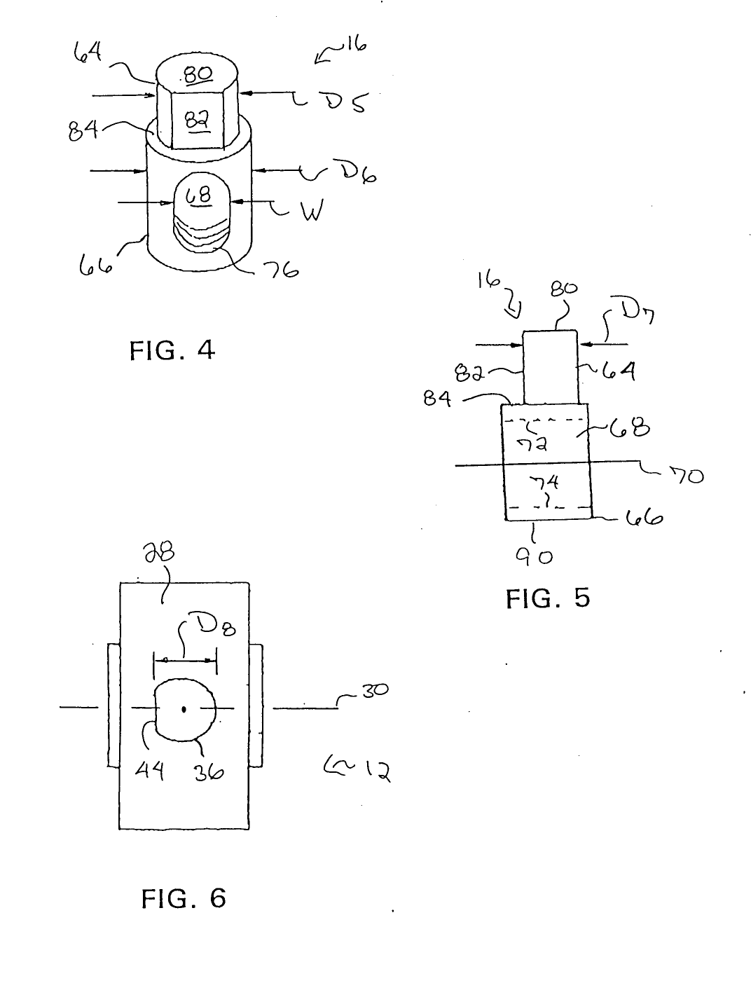

With reference to FIGS. 4-6, the thumb piece 16 includes longitudinally extending operator and actuator segments 64, 66. An elongated transverse aperture 68 extends through the actuator segment 66, defining an axis 70. The transverse aperture 68 extends from a first end 72 to a second end 74 and has a width W which is chosen to closely receive the threaded shaft 20, permitting sliding in a longitudinal direction, but relatively little lateral motion. Preferably, the width W of the transverse aperture 68 is substantially equal to the diameter D₁ of axial bore 22. The second end 74 has an arcuate shape, defining an arc segment of a circle having a diameter commensurate with that of threaded shaft 20, and is threaded 76 in a manner suitable for threaded engagement or mating with the threads 78 of shaft 20.

The thumb piece 16 is slidably disposed within the nut body transverse bore 24, with an outer end 80 of the operator segment 64 positioned to be accessible from the exterior of the nut body 12. With the exception of a longitudinally extending flattened portion 82, the operator segment 64 has a substantially circular cross-section, having an outer diameter D₅ sufficiently large to provide an outer end 80 with sufficient surface area to be easily engaged by the operator's thumb and sufficiently smaller than the inside diameter D₂ of first end segment 36 to allow the operator segment 64 to move freely therein with little lateral movement. In the embodiment shown in FIGS. 1-6, the over all outer diameter D₅ of the operator segment 64 is 0.374 inches, the outer diameter D₇ at flattened portion 82 of operator segment 64 is 0.299 inches, the over all inside diameter D₂ of first end segment 36 is 0.375 inches, and the inside diameter D₈ at flattened section 44 is 0.300 inches.

Since the overall outer diameter D₅ of the operator segment 64 is 0.374 inches and the inside diameter D₈ at the flattened section 44 of first end segment 36 is 0.300 inches, the thumb piece 16 may not be installed within the transverse bore 24 unless flattened portion 82 is positioned next to flattened section 44. Accordingly, the flattened section 44 of first end segment 36 and the flattened portion 82 of operator segment 64 index the thumb piece 16 to the nut body 12 such that transverse aperture 68 is disposed in general registry with nut body axial bore 22. The nut body axial bore 22 and the thumb piece transverse aperture 68, are adapted to cooperatively receive threaded rod 20, as explained below.

The actuator segment 66 of the thumb piece 16 has an outside diameter D₆ which is larger than the outside diameter D₅ of the operator segment 64, defining a circumferential outer shoulder 84 on the thumb piece 16. Biasing means 18, is disposed in the intermediate segment 40 of transverse bore 24 between plug 14 and thumb piece 16 to bias the thumb piece 16 away from the plug 14. Preferably, biasing means 18 is a spring under compression having a first end 86 contacting the inner surface 48 of plug 14 and a second end 88 contacting the inner end 90 of thumb piece 16. As explained below, the compressive spring forces operate parallel to the transverse bore 24 and in the absence of external compressive force, urges threaded second end 74 of transverse aperture 68 into threaded engagement with shaft 20. When the slide nut 10 is not mounted on a threaded rod 20, radial movement of the thumb piece 16 is limited by contact between the thumb piece circumferential outer shoulder 84 and the transverse bore inner shoulder 42, transverse bore inner shoulder 42 acting as a stop. Accordingly, thumb piece 16 and biasing means 18 are retained within transverse bore 24 by plug 14 and contact between shoulder 84 and shoulder 42 when slide nut 10 is not mounted on shaft 20.

With reference to FIGS. 7a and 7b, the slide nut 10 is easily placed in an operative condition in respect of a threaded rod 20, for example of the type disclosed in U.S. Pat. No. 6,438,855. The operator grasps the outer portion 52 of nut body 12, positioning the thumb on the thumb piece outer end 80. Thumb piece 16 is then depressed against the spring force of biasing means 18, moving the threaded second end 74 of transverse aperture 68 away from the axis 30 of the nut body axial bore 22. The slide nut 10 is mounted onto the threaded rod 20 by sliding rod 20 through nut body axial bore 22 and thumb piece transverse aperture 68 until the slide nut 10 is positioned at or near the desired position on rod 20. Thumb piece 16 is then released, whereby biasing means 18 biases the threaded second end 74 of transverse aperture 68 into threaded engagement with the threads 78 of shaft 20. Final positioning of the slide nut 10 may be achieved by rotating the slide nut 10 around rod 20, the threaded engagement between thumb piece 16 and rod 20 transferring such rotary movement into axial movement along the rod 20.

It should be appreciated that positioning an installed slide nut 10 is also quickly and efficiently achieved by depressing thumb piece 16 and axially sliding nut 10 to the new location on rod 20. More particularly, depressing thumb piece 16 radially inward compresses the spring 18, displacing transverse aperture 68 from the engaged position with respect to rod 20 and disengaging threaded second end 74 from the rod 20, thereby allowing axial movement of the slide nut 10 along the threaded shaft 20. The relative lengths of the thumb piece operator and actuator segments 64, 66, the transverse aperture 68, and the transverse bore first end and intermediate segments 36, 40 are selected such that the transverse aperture threaded second end 74 is fully disengaged from the threads 78 of rod 20 before the thumb piece outer end 80 must be depressed below nut body outer surface 28 and before the transverse aperture first end 72 contacts rod 20. Thumb piece 16 is then released, allowing the spring 18 to bias threaded second end 74 into threaded engagement with the threads 78 of shaft 20.

While preferred embodiments have been shown and described, various modifications and substitutions may be made thereto without departing from the spirit and scope of the invention. Accordingly, it is to be understood that the present invention has been described by way of illustration and not limitation.

1. A slide nut mountable on a threaded shaft or rod, the slide nut comprising:
a nut body having an axis and an outer surface, the nut body defining an axial bore adapted for receiving the threaded shaft or rod and a stepped transverse bore extending radially inward from a first point on the outer surface, through the axial bore, and terminating at a second point on the outer surface, the transverse bore including first and second end segments and an intermediate segment disposed therebetween, a stop being disposed intermediate the first end segment and the intermediate segment;
a plug mounted in the second end segment of the nut body transverse bore;
a thumb piece having an actuator segment disposed in the intermediate segment of the nut body transverse bore and an operator segment extending from the actuator segment through the first end segment of the nut body transverse bore to an outer end, a stop being disposed intermediate the actuator segment and the operator segment, the actuator segment defining a transverse aperture extending from a first end proximate to the operator segment to a second end longitudinally spaced from the first end, the second end having a threaded surface; and
a biasing mechanism disposed within the intermediate segment of the nut body transverse bore between the plug and the actuator segment of the thumb piece, the biasing mechanism biasing the thumb piece away from the plug;
wherein, when a threaded shaft or rod is disposed in the axial bore of the nut body the biasing mechanism urges the threaded second end of the transverse aperture into threaded engagement with the threaded shaft or rod and when a threaded shaft or rod is not disposed in the axial bore of the nut body the stop of the thumb piece engages the stop of the nut body transverse bore to limit radial movement of the thumb piece.

2. The slide nut of claim 1 wherein the first and second points are oppositely disposed on the outer surface of the nut body and the transverse bore extends through the axis of the nut body.

3. The slide nut of claim 2 wherein the transverse bore has an axis which intersects the axis of the nut body.

4. The slide nut of claim 1 wherein the first end segment has an inside diameter D₂ and intermediate segment has an inside diameter D₃ which is greater than D₂ forming an inner shoulder within the transverse bore defining the stop of the nut body transverse bore.

5. The slide nut of claim 4 wherein the actuator segment of the thumb piece has an outside diameter D₆ and the operator segment of the thumb piece has an outside diameter D₅ which is less than D₆ forming a circumferential outer shoulder on the thumb piece defining the stop of the thumb piece.

6. The slide nut of claim 1 wherein the first end segment of the transverse bore has an inner surface having a flattened section extending transversely to the axial bore and the operator segment of the thumb piece has a flattened portion extending transversely to the transverse aperture, the flattened section of the first end segment and the flattened portion of the operator segment indexing the thumb piece to the nut body whereby the transverse aperture is disposed in general registry with the nut body axial bore.

7. The slide nut of claim 6 wherein the operator segment of the thumb piece has an overall outer diameter D₅ and an outer diameter D₇ at the flattened portion and the first end segment of the transverse bore has an overall inside diameter D₂ and an inside diameter D₈ at the flattened section, where D₂>D₅>D₈>D₇.

8. The slide nut of claim 1 wherein the plug includes oppositely disposed inner and outer surfaces, the outer surface of the plug and the outer surface of the nut body each having alternating, axially extending ridges and grooves forming a knurled outer surface.

9. The slide nut of claim 8 wherein the plug also includes at least one protrusion and the outer surface of the nut body also has at least one notch for receiving the protrusion, the notch and protrusion indexing the ridges and grooves of the plug to the ridges and grooves of the nut body.

10. The slide nut of claim 1 wherein the axial bore of the nut body has a diameter and the transverse aperture of the thumb piece has a width which is substantially equal to the diameter of the axial bore.

11. The slide nut of claim 10 wherein the second end of the transverse aperture has an arcuate shape.

12. A slide nut mountable on a threaded shaft or rod, the slide nut comprising:
a nut body having an axis and an outer surface, the nut body defining a first bore extending axially therethrough for receiving the threaded shaft or rod and a second bore extending transversely therethrough and intersecting the first bore, the second bore including first and second end segments and an intermediate segment disposed therebetween, the intermediate and first end segments forming a stop;
a plug mounted in the second end segment of the second bore;
a thumb piece disposed in the second bore having actuator and operator segments defining a stop, the operator segment being disposed in the intermediate segment and the operator segment extending from the operator segment through the first end segment to an outer end, the actuator segment defining an aperture in general registry with the first bore of the nut body, the aperture extending from a first end proximate to the operator segment to a threaded second end longitudinally spaced from the first end; and
a spring disposed within the intermediate segment of the nut body second bore between the plug and the actuator segment of the thumb piece, the spring biasing the thumb piece away from the plug;
wherein, when a threaded shaft or rod is disposed in the first bore of the nut body the spring urges the threaded second end of the aperture into threaded engagement with the threaded shaft or rod and when a threaded shaft or rod is not disposed in the first bore of the nut body the stop of the thumb piece engages the stop of the nut body second bore to limit radial movement of the thumb piece.

13. The slide nut of claim 12 wherein the first bore is coaxial with the nut body axis and the second bore has an axis which intersects the nut body axis.

14. The slide nut of claim 12 wherein the first end segment has an inside diameter D₂ and intermediate segment has an inside diameter D₃ which is greater than D₂ forming an inner shoulder within the second bore defining the stop of the nut body second bore and the actuator segment of the thumb piece has an outside diameter D₆ and the operator segment of the thumb piece has an outside diameter D₅ which is less than D₆ forming a circumferential outer shoulder on the thumb piece defining the stop of the thumb piece.

15. The slide nut of claim 12 wherein the first end segment of the second bore has an inner surface having a flattened section extending transversely to the first bore and the operator segment of the thumb piece has a flattened portion extending transversely to the aperture, the operator segment of the thumb piece has an overall outer diameter D₅ and an outer diameter D₇ at the flattened portion and the first end segment of the second bore has an overall inside diameter D₂ and an inside diameter D₈ at the flattened section, where D₂>D₅>D₈>D₇.

16. A slide nut mountable on a threaded shaft or rod, the slide nut comprising:
a nut body having an axis and an outer surface, the nut body defining a first bore extending axially therethrough for receiving the threaded shaft or rod and a second bore extending radially inward from the outer surface, through the first bore, and terminating at an end surface disposed intermediate the first bore and the outer surface, the second bore including first and second end segments and an intermediate segment disposed therebetween, the intermediate and first end segments forming a stop;
a thumb piece disposed in the second bore having actuator and operator segments defining a stop, the operator segment being disposed in the intermediate segment and the operator segment extending from the operator segment through the first end segment to an outer end, the actuator segment defining an aperture in general registry with the first bore of the nut body, the aperture extending from a first end proximate to the operator segment to a threaded second end longitudinally spaced from the first end; and
a spring disposed within the intermediate segment of the nut body second bore between the end of the second bore and the actuator segment of the thumb piece, the spring biasing the thumb piece away from the end of the second bore;
wherein, when a threaded shaft or rod is disposed in the first bore of the nut body the spring urges the threaded second end of the aperture into threaded engagement with the threaded shaft or rod and when a threaded shaft or rod is not disposed in the first bore of the nut body the stop of the thumb piece engages the stop of the nut body second bore to limit radial movement of the thumb piece.
